(19) United States
(12) Patent Application Publication
(10) Pub. No.: US 2023/0287201 A1
(43) Pub. Date: Sep. 14, 2023

(54) Cellulose Ester Polymer Composition and Molded Articles Made Therefrom

(71) Applicant: Celanese International Corporation, Irving, TX (US)

(72) Inventor: Michael Combs, Shady Spring, WV (US)

(21) Appl. No.: 18/120,115

(22) Filed: Mar. 10, 2023

Related U.S. Application Data
(60) Provisional application No. 63/319,010, filed on Mar. 11, 2022.

(51) Int. Cl. C08L 1/12; C08L 67/04

(52) U.S. Cl. CPC C08L 1/12; C08L 67/04; C08L 2201/06; C08L 2203/30

(57) ABSTRACT

A polymer composition containing the reaction product of a cellulose ester polymer and a reactive flow aid. The reactive flow aid can be a polyester oligomer and can be chemically associated with the cellulose ester polymer by being melt blended with the polymer in the presence of a catalyst, such as an acid species. The polymer composition of the present disclosure has excellent flow properties and is well suited for producing molded articles, such as injection molded articles.

### RELATED APPLICATIONS

The present application is based upon and claims priority to U.S. Provisional Patent Application Ser. No. 63/319,010, having a filing date of Mar. 11, 2022, which is incorporated herein by reference.

### BACKGROUND

Each year, the global production of plastics continues to increase. Over one-half of the amount of plastics produced each year are used to produce plastic bottles, containers, drinking straws, and other single-use items. The discarded, single-use plastic articles, including plastic drinking bottles, are typically not recycled and end up in landfills. In addition, many of these items are not properly disposed of and end up in streams, lakes, and oceans around the world.

In view of the above, those skilled in the art have attempted to produce plastic articles made from biodegradable polymers. Many biodegradable polymers, however, lack the physical properties and characteristics of conventional polymers, such as polypropylene and/or polyethylene terephthalate.

Cellulose esters have been proposed in the past as a replacement to some petroleum-based polymers or plastics. Cellulose esters, for instance, are generally considered environmentally friendly polymers because they are recyclable, degradable and derived from renewable resources, such as wood pulp. Problems have been experienced, however, in melt processing cellulose ester polymers, such as cellulose acetate polymers. The polymer materials are relatively stiff and have relatively poor elongation properties. In addition, the melt temperature of cellulose ester polymers is close to the degradation temperature of the polymer, which requires careful control over temperatures during melt processing. Consequently, cellulose esters are typically combined with a plasticizer in order to improve the melt processing properties of the material.

Adding plasticizers to cellulose ester polymers, however, can produce various drawbacks and deficiencies. For example, the plasticizer selected can be less biodegradable than the cellulose ester polymer. In addition, the plasticizer can have an adverse impact on the physical properties of the resulting polymer composition, such as by reducing modulus and stiffness. Plasticizers can also leach out of molded articles made from the polymer composition.

In view of the above, a need exists for an improved method and composition for melt processing cellulose ester polymers. In particular, a need exists for a polymer composition containing a cellulose ester polymer that is capable of being melt processed without containing substantial amounts of conventional plasticizers. A need also exists for a cellulose ester polymer composition that has enhanced biodegradable properties.

### SUMMARY

In general, the present disclosure is directed to a polysaccharide ester polymer composition, particularly a cellulose ester polymer composition, that contains a flow aid agent that reacts with the cellulose ester polymer in the presence of a catalyst in order to improve the melt processing properties of the polymer composition. The polymer composition of the present disclosure is also well suited to producing molded articles having improved mechanical properties. In this manner, cellulose ester polymer compositions can be formulated that contain lesser amounts of plasticizers and can even be free of non-reactive plasticizers. In one embodiment, the reactive flow aid can be a bio-based oligomer that can improve the biodegradable properties of the composition.

In one embodiment, for instance, the present disclosure is directed to a polymer composition comprising the reaction product of a cellulose ester polymer, a catalyst, and a reactive flow aid, which can be a lactone or a polyester oligomer. The polyester oligomer or lactone, for example, can, in one embodiment, become grafted to the cellulose ester polymer and dramatically increase the melt flow rate of the polymer. For example, the resulting polymer composition can have a melt flow rate of greater than about 8 g/10 min, such as greater than about 10 g/10 min, such as greater than about 15 g/10 min, such as greater than about 20 g/10 min, and generally less than about 100 g/10 min.

In one embodiment, the reactive flow aid is a lactone, such as caprolactone.

Alternatively, the reactive flow aid can be a polyester oligomer that comprises a polycaprolactone. The polyester oligomer or polycaprolactone can have a number average molecular weight of less than about 8,000 g/mol, such as less than about 5,000 g/mol, such as less than about 4,000 g/mol, such as less than about 3,000 g/mol, and generally more than 100 g/mol. The polyester oligomer can be present in the polymer composition in an amount greater than about 5% by weight, such as in an amount greater than about 10% by weight, such as in an amount greater than about 15% by weight, such as in an amount greater than about 20% by weight, and generally in an amount less than about 60% by weight, such as in an amount less than about 40% by weight, such as in an amount less than about 30% by weight.

The catalyst can be a catalyst that reacts with the cellulose ester polymer in a way that facilitates reaction with the polyester oligomer. In one aspect, the catalyst can be an acid species having a Pka value of from about 1 to about 8, such as from about 2.5 to about 6, such as from about 3 to about 5.5. The catalyst, for instance, can be an organic acid, such as citric acid. The catalyst can also be stearic acid, oxalic acid, palmitic acid, linoleic acid, lactic acid, acetic acid, formic acid, malic acid, peracetic acid, or combinations thereof. The catalyst is generally present in the polymer composition in an amount greater than about 0.05% by weight and in an amount less than about 10% by weight. For instance, the catalyst can be present in an amount from about 0.08% by weight to about 5% by weight, such as from about 0.1% by weight to about 3% by weight.

The cellulose ester polymer can generally be present in the composition in an amount from about 15% by weight to about 95% by weight, including all increments of 1% by weight therebetween. For instance, the cellulose ester polymer can be present in the polymer composition in an amount greater than about 30% by weight, such as in an amount greater than about 40% by weight, such as in an amount greater than about 50% by weight, such as in an amount greater than about 60% by weight, such as in an amount greater than about 70% by weight.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of a drinking straw that may be made in accordance with the present disclosure;

FIG. 2 is a cross-sectional view of a beverage holder that may be made in accordance with the present disclosure;

FIG. 3 is a side view of one embodiment of a beverage pod that can be made in accordance with the present disclosure;

FIG. 4 is a cross-sectional view of a drinking bottle that may be made in accordance with the present disclosure;

FIG. 5 is a perspective view of an automotive interior illustrating various articles that may be made in accordance with the present disclosure;

FIG. 6 is a perspective view of cutlery made in accordance with the present disclosure;

FIG. 7 is a perspective view of a lid made in accordance with the present disclosure;

FIG. 8 is a perspective view of a container made in accordance with the present disclosure;

FIG. 9 illustrates one embodiment of a medical apparatus comprising a composition prepared according to the present disclosure;

FIG. 10 illustrates another embodiment of a medical apparatus comprising a composition prepared according to the present disclosure;

FIG. 11 illustrates still another embodiment of a medical apparatus comprising a composition prepared according to the present disclosure; and

FIG. 12 illustrates another embodiment of a medical apparatus comprising a composition prepared according to the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

In general, the present disclosure is directed to polymer compositions containing a polysaccharide ester polymer, particularly a cellulose ester polymer with improved melt processing properties and/or physical properties. Polymer compositions formulated in accordance with the present disclosure, for instance, can have dramatically and unexpectedly improved melt flow properties in combination with excellent melt strength. In addition, the polymer composition of the present disclosure can be formulated to have enhanced biodegradability, especially in comparison to many conventional formulations. The polymer composition can be used to form all different types of molded products and articles using any suitable molding technique, such as extrusion, injection molding, rotational molding, thermoforming, and the like.

In one aspect, the polymer composition of the present disclosure contains a cellulose ester polymer in combination with a reactive flow aid in the presence of a catalyst. The reactive flow aid can comprise, for example, a lactone or a polyester oligomer. In one embodiment, the lactone or polyester oligomer can be derived from bio-based materials, thus enhancing the biodegradable characteristics of the polymer composition. Although unknown, it is believed that the reactive flow aid in the presence of a catalyst chemically associates with the cellulose ester polymer. Although unknown, it is believed that the reactive flow aid grafts to the cellulose ester polymer chains. In this manner, the reactive flow aid improves the melt processing characteristics of the cellulose ester polymer. In fact, the reactive flow aid of the present disclosure can be used without having to incorporate into the polymer composition a plasticizer. Alternatively, the flow aid can be used in conjunction with a plasticizer.

Reducing or eliminating the use of a plasticizer in the polymer composition can provide various advantages and benefits. For instance, the polymer composition of the present disclosure is less likely to experience leaching of a plasticizer contained in the composition. The reactive flow aid of the present disclosure can also, in one embodiment, better maintain the physical properties or mechanical properties of the cellulose ester polymer in comparison to a composition containing the cellulose ester polymer and various plasticizers. Because the reactive flow aid forms a chemical association with the cellulose ester polymer, it is also believed that molded articles formed from the polymer composition may display an improved visual appearance through better homogeneous blending.

The polymer composition of the present disclosure contains at least one polysaccharide ester polymer, and particularly a cellulose ester polymer. Any suitable cellulose ester polymer, for instance, can be incorporated into the polymer composition of the present disclosure, as long as the polymer is capable of reacting with the reactive flow aid.

In one embodiment, the cellulose ester polymer incorporated into the polymer composition is a cellulose acetate. Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hardwood, hardwood pulp, softwood, softwood pulp, cotton linters, switchgrass, bagasse, herbs, recycled paper, waste paper, wood chips, pulp and paper wastes, waste wood, thinned wood, willow, poplar, perennial grasses (e.g., grasses of the Miscanthus family), bacterial cellulose, seed hulls (e.g., soy beans), cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

Cellulose esters suitable for use in producing the composition of the present disclosure may, in some embodiments, have ester substituents that include, but are not limited to, C₁-C₂₀ aliphatic esters (e.g., acetate, propionate, or butyrate), functional C₁-C₂₀ aliphatic esters (e.g., succinate, glutarate, maleate) aromatic esters (e.g., benzoate or phthalate), substituted aromatic esters, and the like, any derivative thereof, and any combination thereof.

The cellulose acetate used in the composition may be cellulose diacetate or cellulose triacetate. In one embodiment, the cellulose acetate comprises primarily cellulose diacetate. For example, the cellulose acetate can contain less than 1% by weight cellulose triacetate, such as less than about 0.5% by weight cellulose triacetate. Cellulose diacetate can make up greater than 90% by weight of the cellulose acetate, such as greater than about 95% by weight, such as greater than about 98% by weight, such as greater than about 99% by weight of the cellulose acetate.

In general, the cellulose acetate can have a molecular weight of greater than about 10,000 g/mol, such as greater than about 20,000 g/mol, such as greater than about 30,000 g/mol, such as greater than about 40,000 g/mol, such as greater than about 50,000 g/mol. The molecular weight of the cellulose acetate is generally less than about 300,000 g/mol, such as less than about 250,000 g/mol, such as less than about 200,000 g/mol, such as less than about 150,000 g/mol, such as less than about 100,000 g/mol, such as less than about 90,000 g/mol, such as less than about 70,000 g/mol, such as less than about 50,000 g/mol. The molecular weights identified above refer to the number average molecular weight. Molecular weight can be determined using gel permeation chromatography using a polystyrene equivalent or standard.

The cellulose ester polymer or cellulose acetate, before being combined with the reactive flow aid and the catalyst, can have an intrinsic viscosity of generally greater than about 0.5 dL/g, such as greater than about 1 dL/g, such as greater than about 1.2 dL/g, such as greater than about 1.4 dL/g, such as greater than about 1.5 dL/g, such as greater than about 1.6 dL/g. The intrinsic viscosity is generally less than about 2 dL/g, such as less than about 1.8 dL/g, such as less than about 1.7 dL/g, such as less than about 1.65 dL/g. Intrinsic viscosity may be measured by forming a solution of 0.20 g/dL cellulose ester in 98/2 wt/wt acetone/water and measuring the flow times of the solution and the solvent at 30° C. in a #25 Cannon-Ubbelohde viscometer. Then, the modified Baker-Philippoff equation may be used to determine intrinsic viscosity (“IV”), which for this solvent system is Equation 1.

$$IV = ( \frac{k}{c} ) ( antilog ( ( log {n}_{ret} ) / k ) - 1 ) \\ where {n}_{rel} = ( \frac{{t}_{1}}{{t}_{2}} ) , \qquad Equation 1$$

t₁=the average flow time of solution (having cellulose ester) in seconds, t₂=the average flow times of solvent in seconds, k=solvent constant (10 for 98/2 wt/wt acetone/water), and c=concentration (0.200 g/dL).

The cellulose ester polymer can generally have a degree of substitution of greater than about 1.5, such as greater than about 2, such as greater than about 2.2, such as greater than about 2.3, such as greater than about 2.4, such as greater than about 2.5. The degree of substitution is generally less than about 3.1, such as less than about 2.9, such as less than about 2.8, such as less than about 2.7, such as less than about 2.65.

The cellulose acetate is generally present in the polymer composition in an amount greater than about 5% by weight, such as in an amount greater than about 25% by weight, such as in an amount greater than about 35% by weight, such as in an amount greater than about 45% by weight, such as in an amount greater than about 55% by weight, such as greater than about 65% by weight, such as greater than about 75% by weight, such as greater than about 85% by weight. The cellulose acetate is generally present in the polymer composition in an amount less than about 95% by weight, such as in an amount less than about 85% by weight, such as in an amount less than about 75% by weight, such as in an amount less than about 70% by weight, such as in an amount less than about 65% by weight.

In accordance with the present disclosure, the polysaccharide ester polymer or cellulose ester polymer is combined with a reactive flow aid in the presence of a catalyst that is believed to cause a chemical interaction to occur between the cellulose ester polymer and the flow aid. In one aspect, the reactive flow aid can be a lactone or a polyester oligomer that attaches to the cellulose ester polymer chains in the presence of the catalyst. The catalyst, for instance, can be an acid species. Although unknown, it is believed that the acid species can attach to the cellulose ester polymer and serve as a crosslinking agent and/or cause chain scission of the cellulose ester polymer chains creating more reactive sites for the reactive flow aid. In one aspect, both of the above may be occurring simultaneously. Through one or more mechanisms, the catalyst of the present disclosure can significantly and dramatically enhance reaction between the reactive flow aid and the cellulose ester polymer. It is believed that the reactive flow aid, such as the polyester oligomer, becomes grafted to the cellulose ester polymer. The reactive flow aid, such as the polyester oligomer, was found to behave similar to a plasticizer and cause the melt flow rate of the resulting polymer composition to be significantly increased.

In general, any suitable lactone or polyester oligomer may be used in accordance with the present disclosure. Of particular advantage, in one embodiment, the lactone or polyester oligomer can comprise a biodegradable compound or polyester. In fact, in one embodiment, the lactone or polyester oligomer can be a bio-based compound or oligomer. The lactone may comprise caprolactone. Alternatively, the reactive flow aid can be a lactone-based oligomer, such as a fatty acid modified lactone. In one particular embodiment, for instance, the polyester oligomer can comprise polycaprolactone.

The polyester oligomer, such as the polycaprolactone, can have, in one aspect, a number average molecular weight of less than about 8,000 g/mol, such as less than about 5,000 g/mol, such as less than about 4,000 g/mol, such as less than about 3,000 g/mol, such as less than about 2,000 g/mol, such as less than about 1,000 g/mol, such as less than about 900 g/mol, such as less than about 800 g/mol, such as less than about 700 g/mol, such as less than about 600 g/mol. The number average molecular weight of the polyester oligomer, such as the polycaprolactone, can be greater than about 100 g/mol, such as greater than about 200 g/mol, such as greater than about 300 g/mol, such as greater than about 400 g/mol, such as greater than about 500 g/mol.

The polyester oligomer used in the process of the present disclosure, in one aspect, can have a relatively low melting point and glass transition temperature. For example, the melting point of the oligomer can be less than about 80° C., such as less than about 70° C., such as less than about 65° C., and generally greater than about 20° C., such as greater than about 30° C., such as greater than about 40° C., such as greater than about 50° C. The glass transition temperature of the polyester oligomer can be less than about −10° C., such as less than about −20° C., such as less than about −30° C., such as less than about −40° C., such as less than about −50° C., and generally greater than about −100° C., such as greater than about −80° C.

In general, the reactive flow aid can be present in the polymer composition in an amount from about 5% by weight to about 60% by weight, including all increments of 1 wt. % therebetween. For example, the reactive flow aid or polyester oligomer can be present in the polymer composition in an amount greater than about 10% by weight, such as in an amount greater than about 15% by weight, such as in an amount greater than about 20% by weight, and generally in an amount less than about 55% by weight, such as in an amount less than about 45% by weight, such as in an amount less than about 35% by weight, such as in an amount less than about 30% by weight.

In forming the polymer composition of the present disclosure, the cellulose ester polymer and the reactive flow aid are melt blended together in the presence of a catalyst. The catalyst can be an acid species.

Various different types of acidic species may be used as the catalyst. In one embodiment, the catalyst includes terminal hydroxyl groups, such as terminal carboxyl groups. For instance, the acid species can contain greater than two, such as greater than three, such as greater than four, and generally less than about eight, such as less than about six terminal hydroxyl groups.

In one embodiment, the acidic species can be an organic acid. One particular organic acid well suited for use in the composition of the present disclosure is citric acid. Other acids well suited for use in the present disclosure include stearic acid and oxalic acid. In still other embodiments, the catalyst can be palmitic acid, linoleic acid, lactic acid, acetic acid, formic acid, malic acid, peracetic acid, and the like. Any of the above catalysts can be used alone or in combination. For example, citric acid may be used in combination with stearic acid and/or oxalic acid.

The amount of catalyst incorporated into the polymer composition can depend upon various factors including the molecular weight of the polysaccharide ester polymer and the desired resulting melt flow rate of the composition. In general, one or more catalysts can be present in the composition in an amount from about 0.05% to about 10% by weight, including all increments of 0.1% by weight therebetween. For example, one or more catalysts can be present in the composition in an amount greater than about 0.5% by weight, such as in an amount greater than about 0.8% by weight, such as in an amount greater than about 1% by weight, such as in an amount greater than about 1.2% by weight, such as in an amount greater than about 1.4% by weight, such as in an amount greater than about 1.6% by weight, such as in an amount greater than about 1.8% by weight, such as in an amount greater than about 2% by weight, such as in an amount greater than about 2.2% by weight, such as in an amount greater than about 2.4% by weight, such as in an amount greater than about 2.6% by weight. One or more catalysts are generally present in the composition in an amount less than about 8% by weight, such as in an amount less than about 6% by weight, such as in an amount less than about 5% by weight, such as in an amount less than about 4.5% by weight, such as in an amount less than about 4% by weight, such as in an amount less than about 3.5% by weight, such as in an amount less than about 3% by weight.

The amount of the reactive flow aid and the amount of catalyst that is incorporated into the polymer composition can be used to control the melt flow rate of the composition. For example, in one embodiment, the polyester oligomer can be incorporated into the cellulose ester polymer in order to increase the melt flow rate of the polymer by at least about 10%, such as by at least about 20%, such as by at least about 30%, such as by at least about 50%, such as by at least about 100%, such as by at least about 200%, such as by at least about 300%, such as by at least about 400%, such as by at least about 500%, such as by at least about 600%, such as by at least about 700%, such as by at least about 800%, and generally less than about 2,000%. Unless otherwise indicated, melt flow rate as used herein is determined at 190° C. and at a load of 2.16 kg according to ASTM Test D1238-13. Melt flow can also be determined at a load of 2.16 kg and at a temperature of 200 C or at a temperature of 210 C.

The melt flow rate of the polymer composition of the present disclosure can be from about 2 g/10 min to about 70 g/10 min. In one aspect, the melt flow rate is greater than about 7 g/10 min, such as greater than about 10 g/10 min, such as greater than about 12 g/10 min, such as greater than about 15 g/10 min, such as greater than about 18 g/10 min, such as greater than about 20 g/10 min, such as greater than about 22 g/10 min, and generally less than about 50 g/10 min, such as less than about 40 g/10 min, such as less than about 30 g/10 min.

The polymer composition of the present disclosure can optionally contain one or more non-reactive plasticizers. In one embodiment, however, the polymer composition does not contain any non-reactive plasticizers. In fact, when formulated not to contain any plasticizers, the polymer composition may have improved mechanical properties and can be formulated to be resistant to any leaching that normally occurs with some plasticizers.

When a plasticizer is contained in the polymer composition, any suitable plasticizer may be used. When a plasticizer is present, in one embodiment, the plasticizer is a polyalkylene glycol, such as polyethylene glycol. The polyethylene glycol can have a number average molecular weight of generally less than about 2,000 g/mol, such as less than about 1,600 g/mol. In one embodiment, a lower molecular weight polyethylene glycol may be used having a number average molecular weight of less than about 1,000 g/mol, such as less than about 800 g/mol, and generally greater than about 100 g/mol, such as greater than about 300 g/mol. Using a polyethylene glycol plasticizer, for instance, may not adversely impact the ability of the polymer composition to biodegrade.

In other embodiments, the plasticizer may comprise triacetin, monoacetin, diacetin, and mixtures thereof. Other suitable plasticizers include tris(clorisopropyl) phosphate, tris(2-chloro-1-methylethyl) phosphate, triethyl citrate, acetyl triethyl citrate, glycerin, or mixtures thereof.

Other examples of plasticizers include, but are not limited to, trimethyl phosphate, triethyl phosphate, tributyl phosphate, triphenyl phosphate, acetyl tributyl citrate, tributyl-o-acetyl citrate, dibutyl tartrate, ethyl o-benzoylbenzoate, n-ethyltoluenesulfonamide, o-cresyl p-toluenesulfonate, aromatic diol, substituted aromatic diols, aromatic ethers, tripropionin, tribenzoin, glycerin, glycerin esters, glycerol tribenzoate, glycerol acetate benzoate, polyethylene glycol esters, polyethylene glycol diesters, di-2-ethylhexyl polyethylene glycol ester, glycerol esters, diethylene glycol, polypropylene glycol, polyglycoldiglycidyl ethers, dimethyl sulfoxide, N-methyl pyrollidinone, propylene carbonate, C₁-C₂₀ dicarboxylic acid esters, dimethyl adipate (and other dialkyl esters), di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, alkyl lactones (e.g., .gamma.-valerolactone), alkylphosphate esters, aryl phosphate esters, phospholipids, aromas (including some described herein, e.g., eugenol, cinnamyl alcohol, camphor, methoxy hydroxy acetophenone (acetovanillone), vanillin, and ethylvanillin), 2-phenoxyethanol, glycol ethers, glycol esters, glycol ester ethers, polyglycol ethers, polyglycol esters, ethylene glycol ethers, propylene glycol ethers, ethylene glycol esters (e.g., ethylene glycol diacetate), propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, glyceryl tribenzoate, neopentyl dibenzoate, triethylene glycol dibenzoate, trimethylolethane tribenzoate, butylated hydroxytoluene, butylated hydroxyanisol, sorbitol, xylitol, ethylene diamine, piperidine, piperazine, hexamethylene diamine, triazine, triazole, pyrrole, and the like, any derivative thereof, and any combination thereof.

In one aspect, a carbonate ester may serve as a plasticizer. Exemplary carbonate esters may include, but are not limited to, propylene carbonate, butylene carbonate, diphenyl carbonate, phenyl methyl carbonate, dicresyl carbonate, glycerin carbonate, dimethyl carbonate, diethyl carbonate, ethylene carbonate, propylene carbonate, isopropylphenyl 2-ethylhexyl carbonate, phenyl 2-ethylhexyl carbonate, isopropylphenyl isodecyl carbonate, isopropylphenyl tridecyl carbonate, phenyl tridecyl carbonate, and the like, and any combination thereof.

In still another aspect, the plasticizer can be a polyol benzoate. Exemplary polyol benzoates may include, but are not limited to, glyceryl tribenzoate, propylene glycol dibenzoate, diethylene glycol dibenzoate, dipropylene glycol dibenzoate, triethylene glycol dibenzoate, sucrose benzoate, polyethylene glycol dibenzoate, neopentylglycol dibenzoate, trimethylolpropane tribenzoate, trimethylolethane tribenzoate, pentaerythritol tetrabenzoate, sucrose benzoate (with a degree of substitution of 1-8), and combinations thereof. In some instances, tribenzoates like glyceryl tribenzoate may be preferred. In some instances, polyol benzoates may be solids at 25° C. and a water solubility of less than 0.05 g/100 mL at 25° C.

The plasticizer can also be bio-based. For example, using a bio-based plasticizer can render the polymer composition well suited for contact with food items. Bio-based plasticizers particularly well suited for use in the composition of the present disclosure include an alkyl ketal ester, a non-petroleum hydrocarbon ester, a bio-based polymer or oligomer, such as polycaprolactone, having a number average molecular weight of 1000 g/mol or less, or mixtures thereof.

In one aspect, the bio-based plasticizer is an alkyl ketal ester having a chemical structure corresponding to Structure l as provided below:

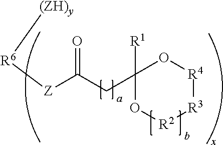

wherein a is from 0 to 12; b is 0 or 1; each R¹ is independently hydrogen, a hydrocarbyl group, or a substituted hydrocarbyl group; each R², R³, and R⁴ are independently methylene, alkylmethylene, or dialkylmethylene, x is at least 1, y is 0 or a positive number and x+y is at least 2; R⁶ is a hydrocarbyl group or a substituted hydrocarbyl group and each Z is independently —O—, —NH— or —NR— where R is a hydrocarbyl group or a substituted hydrocarbyl group.

The plasticizer identified above corresponds to a reaction product of a polyol, aminoalcohol or polyamine and certain 1,2- and/or 1,3-alkanediol ketal of an oxocarboxylate esters. 1,2- and 1,3-alkanediols ketals of oxocarboxylate esters are referred to herein as “alkyl ketal esters”. Up to one mole of alkyl ketal ester can be reacted per equivalent of hydroxyl groups or amino groups provided by the polyol, aminoalcohol or polyamine. The polyol, aminoalcohol or polyamine is most preferably difunctional, but polyols, aminoalcohols and polyamines having more than two hydroxyl and/or amino groups can be used.

The values of x and y in structure l will depend on the number of hydroxyl groups or amino groups on the polyol, aminoalcohol or polyamine, the number of moles of the alkyl ketal ester per mole of the polyol, aminoalcohol or polyamine, and the extent to which the reaction is taken towards completion. Higher amounts of the alkyl ketal ester favor lower values for y and higher values of x.

In structure l, y is specifically from 0 to 2 and x is specifically at least 2. All a in structure l are specifically 2 to 12, more specifically, 2 to 10, more specifically, 2 to 8, more specifically, 2 to 6, more specifically, 2 to 4, and more specifically, 2. All R¹ are specifically an alkyl group, specifically methyl. In some embodiments of structure l, all Z are —O—, y is 0 and x is 2; these products correspond to a reaction of two moles of an alkyl ketal ester and one mole of a diol. In some other embodiments, all Z are —O—, y is 1 and x is 1; these products correspond to the reaction of one mole of the alkyl ketal ester and one mole of a diol.

In one embodiment, all b are 0. In another embodiment, all b are 1.

Some specific compounds according to structure l include those having the structure:

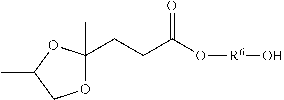

or the structure

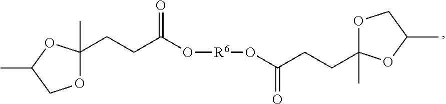

or the structure

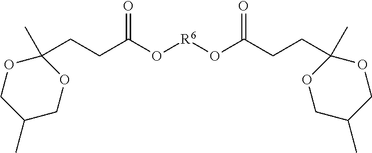

particularly in which R⁶ is —(CH₂)—ₘ wherein m is from 2 to 18, especially 2, 3, 4 or 6. In one specific embodiment, R⁶ corresponds to the residue, after removal of hydroxyl groups, of 1,4-butane diol resulting in the structure (Ia)

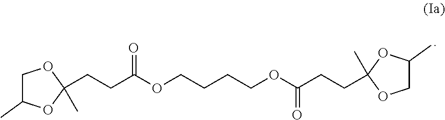

In another specific embodiment, R⁶ corresponds to the residue, after removal of hydroxyl groups, of diethylene glycol resulting in structure (Ib)

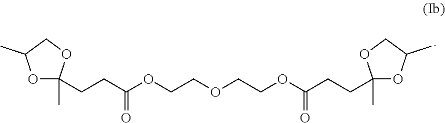

In another specific embodiment, R⁶ corresponds to the residue, after removal of hydroxyl groups, of 2-methyl. 1-3 propane diol resulting in structure (Ic)

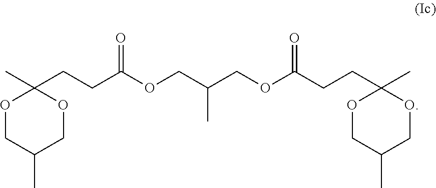 [SMILES: CC(COC(=O)CCC1(C)OCC(C)CO1)COC(=O)CCC1(C)OCC(C)CO1]

Compounds according to structure l can be prepared in a transesterification or ester-aminolysis reaction between the corresponding polyol, aminoalcohol or polyamine and the corresponding alkyl ketal ester. Alternatively, compounds according to structure l can be prepared by reacting an oxocarboxylic acid with the polyol, aminoalcohol or polyamine to form an ester or amide, and then ketalizing the resulting product with a 1,2- or 1,3-alkane diol such as ethylene glycol, 1,2-propanediol, 1,3-propanediol, 2-methyl, 1-3 propane diol, 1,2-butanediol, 1,3-butanediol, 1,2-pentanediol, 1,3-pentanediol, 1,2-hexanediol, 1,3-hexanediol, and the like.

Another bio-based plasticizer that may be incorporated into the polymer composition of the present disclosure is a non-petroleum hydrocarbon ester. For example, one example of a non-petroleum hydrocarbon ester is sold under the tradename HALLGREEN by the Hall Star Company of Chicago, Ill. Non-petroleum hydrocarbon ester plasticizers, for instance, can contain greater than about 50% by weight, such as greater than about 70% by weight, such as greater than about 99% by weight of bio-based content. The esters, for instance, can be derived primarily from agricultural, forestry, or marine materials and thus are biodegradable. In one aspect, the non-petroleum hydrocarbon ester plasticizer has a specific gravity at 25° C. of about 1.16 or greater, such as about 1.165 or greater, such as about 1.17 or greater, such as about 1.74 or greater, and generally about 1.19 or less, such as about 1.185 or less, such as about 1.18 or less, such as about 1.78 or less. The non-petroleum hydrocarbon ester plasticizer can have an acid value of from about 0.5 mgKOH/g to about 0.6 mgKOH/g, such as from about 0.53 mgKOH/g to about 0.57 mgKOH/g.

In one aspect, the plasticizer is phthalate-free. In fact, the polymer composition can be formulated to be phthalate-free. For instance, phthalates can be present in the polymer composition in an amount of about 0.5% or less, such as in an amount of about 0.1% or less.

In general, one or more plasticizers can be present in the polymer composition in an amount from about 2% to about 40% by weight, such as in an amount from about 3% to about 20% by weight. In one aspect, one or more plasticizers can be present in the polymer composition in an amount of about 18% or less, such as in an amount of about 15% or less, such as in an amount of about 10% or less, such as in an amount of about 8% or less, such as in an amount of about 5% or less. One or more plasticizers can be present in an amount from about 2% or greater, such as in an amount of about 3% or greater.

In one aspect, an acid scavenger can also be present in the polymer composition. The acid scavenger can be a carbonate, an oxide, a hydroxide, an amine, or mixtures thereof. Examples of acid scavengers include zinc oxide, magnesium oxide, magnesium hydroxide, aluminum sodium carbonate, an aluminum silicate, a hydrotalcite, or mixtures thereof. One or more acid scavengers can be present in the polymer composition generally in an amount greater than about 0.1% by weight, such as greater than about 0.5% by weight, such as greater than about 1% by weight, and generally less than about 2.5% by weight, such as less than about 2% by weight, such as less than about 1.5% by weight.

The polymer composition may also contain antioxidants, pigments, lubricants, softening agents, antibacterial agents, antifungal agents, preservatives, flame retardants, and combinations thereof. Each of the above additives can generally be present in the polymer composition in an amount of about 5% or less, such as in an amount of about 2% or less, and generally in an amount of about 0.1% or greater, such as in an amount of about 0.3% or greater.

Flame retardants suitable for use in conjunction with a cellulose ester plastic described herein may, in some embodiments, include, but are not limited to, silica, metal oxides, phosphates, catechol phosphates, resorcinol phosphates, borates, inorganic hydrates, aromatic polyhalides, and the like, and any combination thereof.

Antifungal and/or antibacterial agents suitable for use in conjunction with a cellulose ester plastic described herein may, in some embodiments, include, but are not limited to, polyene antifungals (e.g., natamycin, rimocidin, filipin, nystatin, amphotericin B, candicin, and hamycin), imidazole antifungals such as miconazole (available as MICATIN® from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CANESTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocandin antifungals (e.g., anidulafungin, caspofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Preservatives suitable for use in conjunction with a cellulose ester plastic described herein may, in some embodiments, include, but are not limited to, benzoates, parabens (e.g., the propyl-4-hydroxybenzoate series), and the like, and any combination thereof.

Pigments and dyes suitable for use in conjunction with a cellulose ester plastic described herein may, in some embodiments, include, but are not limited to, plant dyes, vegetable dyes, titanium dioxide, silicon dioxide, tartrazine, E102, phthalocyanine blue, phthalocyanine green, quinacridones, perylene tetracarboxylic acid di-imides, dioxazines, perinones disazo pigments, anthraquinone pigments, carbon black, metal powders, iron oxide, ultramarine, calcium carbonate, kaolin clay, aluminum hydroxide, barium sulfate, zinc oxide, aluminum oxide, CARTASOL® dyes (cationic dyes, available from Clariant Services) in liquid and/or granular form (e.g., CARTASOL® Brilliant Yellow K-6G liquid, CARTASOL® Yellow K-4GL liquid, CARTASOL® Yellow K-GL liquid, CARTASOL® Orange K-3GL liquid, CARTASOL® Scarlet K-2GL liquid, CARTASOL® Red K-3BN liquid, CARTASOL® Blue K-5R liquid, CARTASOL® Blue K-RL liquid, CARTASOL® Turquoise K-RL liquid/granules, CARTASOL® Brown K-BL liquid), FASTUSOL® dyes (an auxochrome, available from BASF) (e.g., Yellow 3GL, Fastusol C Blue 74L), and the like, any derivative thereof, and any combination thereof.

In some embodiments, pigments and dyes suitable for use in conjunction with a cellulose ester plastic described herein may be food-grade pigments and dyes. Examples of food-grade pigments and dyes may, in some embodiments, include, but are not limited to, plant dyes, vegetable dyes, titanium dioxide, and the like, and any combination thereof.

Antioxidants may, in some embodiments, mitigate oxidation and/or chemical degradation of a cellulose ester plastic described herein during storage, transportation, and/or implementation. Antioxidants suitable for use in conjunction with a cellulose ester plastic described herein may, in some embodiments, include, but are not limited to, anthocyanin, ascorbic acid, glutathione, lipoic acid, uric acid, resveratrol, flavonoids, carotenes (e.g., beta-carotene), carotenoids, tocopherols (e.g., alpha-tocopherol, beta-tocopherol, gamma-tocopherol, and delta-tocopherol), tocotrienols, tocopherol esters (e.g., tocopherol acetate), ubiquinol, gallic acids, melatonin, secondary aromatic amines, benzofuranones, hindered phenols, polyphenols, hindered amines, organophosphorus compounds, thioesters, benzoates, lactones, hydroxylamines, butylated hydroxytoluene (“BHT”), butylated hydroxyanisole (“BHA”), hydroquinone, and the like, and any combination thereof.

In some embodiments, antioxidants suitable for use in conjunction with a cellulose ester plastic described herein may be food-grade antioxidants. Examples of food-grade antioxidants may, in some embodiments, include, but are not limited to, ascorbic acid, vitamin A, tocopherols, tocopherol esters, beta-carotene, flavonoids, BHT, BHA, hydroquinone, and the like, and any combination thereof.

In one embodiment, the polymer composition contains an antioxidant comprising a phosphorus compound, particularly a phosphite. For instance, in one embodiment, the antioxidant can be a diphosphite. For example, in one embodiment, the antioxidant is a pentaerythritol diphosphite, such as bis(2,4-dicumylphenyl)pentaerythritol diphosphite. The antioxidant can be present in the polymer composition generally in an amount less than about 2% by weight, such as in an amount less than about 1% by weight, such as in an amount less than about 0.5% by weight, such as in an amount less than about 0.3% by weight. The antioxidant can be present in the polymer composition generally in an amount greater than about 0.05% by weight, such as in an amount greater than about 0.08% by weight, such as in an amount greater than about 0.1% by weight, such as in an amount greater than about 0.13% by weight.

The polymer composition of the present disclosure can be formed into any suitable polymer article using any technique known in the art. For instance, polymer articles can be formed from the polymer composition through extrusion, injection molding, blow molding, and the like.

In one aspect, the polymer composition containing the cellulose acetate can be formulated such that the polymer composition has properties very comparable to petroleum-based polymers, such as polypropylene. By matching the physical properties of a petroleum-based polymer, the polymer composition of the present disclosure is well suited to replacing those polymers in many different end use applications.

Polymer articles that may be made in accordance with the present disclosure include drinking straws, beverage holders, automotive parts, knobs, door handles, consumer appliance parts, and the like.

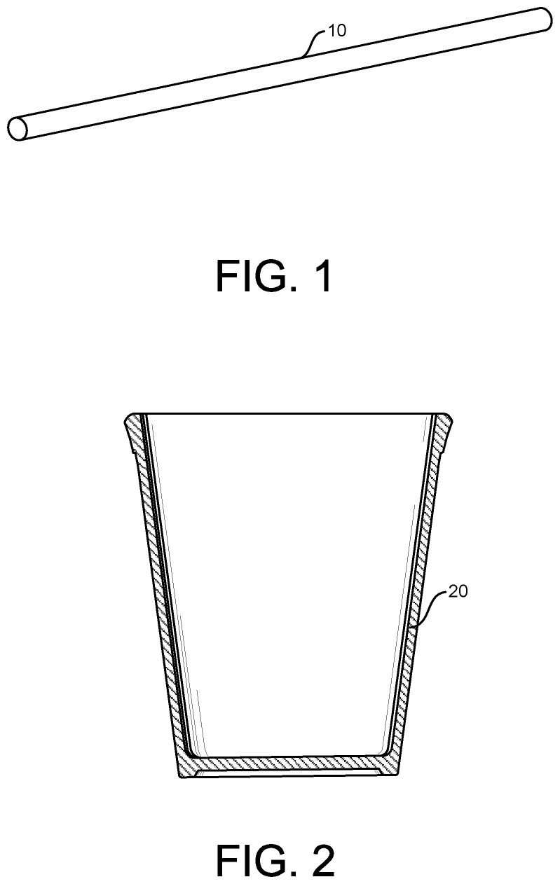

For instance, referring to FIG. 1, a drinking straw 10 is shown that can be made in accordance with the present disclosure. In the past, drinking straws were conventionally made from petroleum-based polymers, such as polypropylene. The cellulose acetate polymer composition of the present disclosure, however, can be formulated so as to match the physical properties of polypropylene. Thus, drinking straws 10 can be produced in accordance with the present disclosure and be completely biodegradable.

Referring to FIG. 2, a cup or beverage holder 20 is shown that can also be made in accordance with the present disclosure. The cup 20 can be made, for instance, using injection molding or through any suitable thermoforming process. As shown in FIG. 7, a lid 22 for the cup 20 can also be made from the polymer composition of the present disclosure. The lid can include a pour spout 24 for dispensing a beverage from the cup 20. In addition to lids for beverage holders, the polymer composition of the present disclosure can be used to make lids for all different types of containers, including food containers, package containers, storage containers and the like.

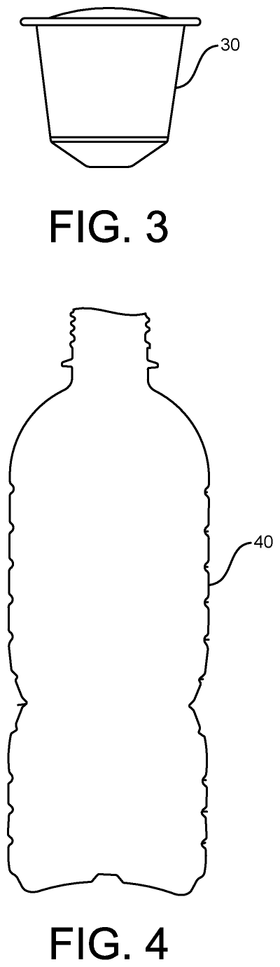

In still another embodiment, the polymer composition can be used to produce a hot beverage pod 30 as shown in FIG. 3. In addition to the beverage pod 30, the polymer composition can also be used to produce a plastic bottle 40 as shown in FIG. 4, which can serve as a water bottle or other sport drink container.

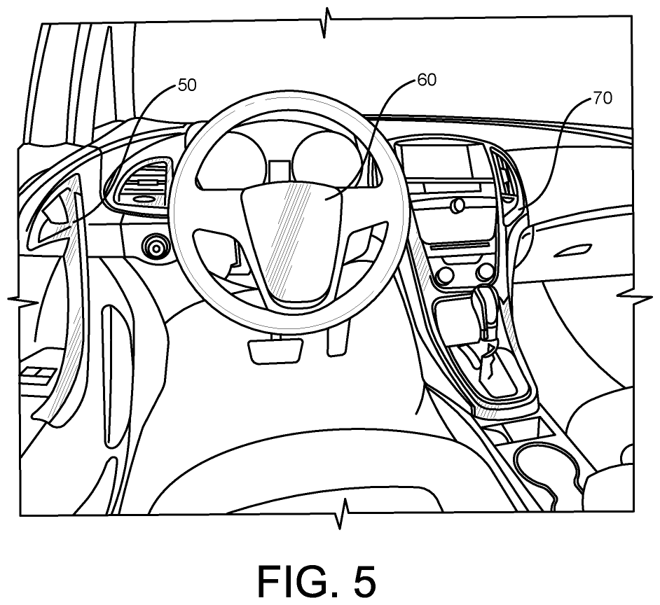

Referring to FIG. 5, an automotive interior is illustrated. The automotive interior includes various automotive parts that may be made in accordance with the present disclosure. The polymer composition, for instance, can be used to produce automotive part 50, which comprises at least a portion of an interior door handle. The polymer composition may also be used to produce a part on the steering column, such as automotive part 60. In general, the polymer composition can be used to mold any suitable decorative trim piece or bezel, such as trim piece 70. In addition, the polymer composition can be used to produce knobs or handles that may be used on the interior of the vehicle.

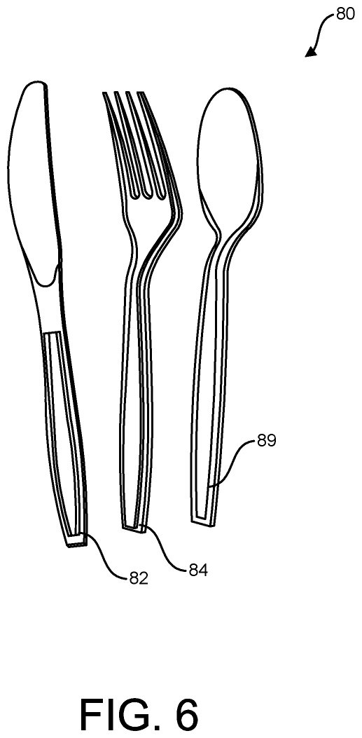

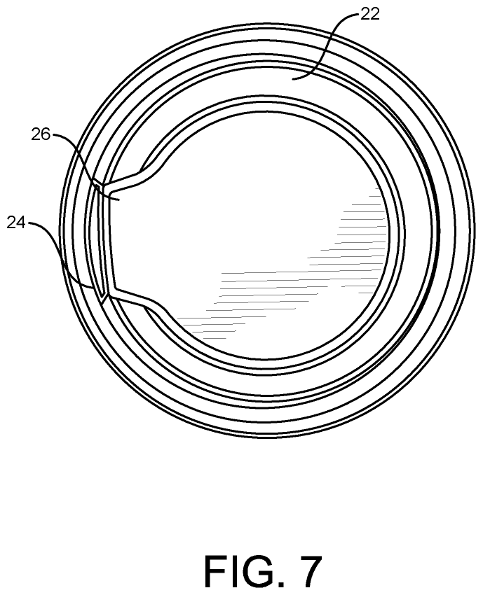

The polymer composition is also well suited to producing cutlery, such as forks, spoons, and knives. For example, referring to FIG. 6, disposable cutlery 80 is shown. The cutlery 80 includes a knife 82, a fork 84, and a spoon 86.

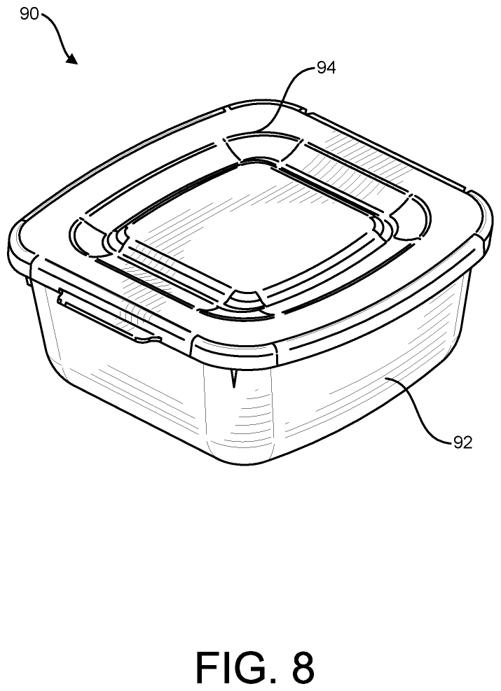

In still another embodiment, the polymer composition can be used to produce a storage container 90 as shown in FIG. 8. The storage container 90 can include a lid 94 that cooperates and engages the rim of a bottom 92. The bottom 92 can define an interior volume for holding items. The container 90 can be used to hold food items or dry goods.

In still other embodiments, the polymer composition can be formulated to produce paper plate liners, eyeglass frames, screwdriver handles, or any other suitable part.

The cellulose ester composition of the present disclosure is also particularly well-suited for use in producing medical devices including all different types of medical instruments. The cellulose ester composition, for instance, is well suited to replacing other polymers used in the past, such as polycarbonate polymers. Not only is the cellulose ester composition of the present disclosure biodegradable, but the composition has a unique “warm touch” feel when handled. Thus, the composition is particularly well suited for constructing housings for medical devices. When held or grasped, for instance, the polymer composition retains heat and makes the device or instrument feel warmer than devices made from other materials in the past. The sensation is particularly soothing and comforting to those in need of medical assistance and can also provide benefits to medical providers. In one aspect, the cellulose ester composition used to produce housings for medical devices includes a cellulose ester polymer combined with a plasticizer (e.g. triacetin) and optionally another bio-based polymer. In addition, the composition can contain one or more coloring agents.

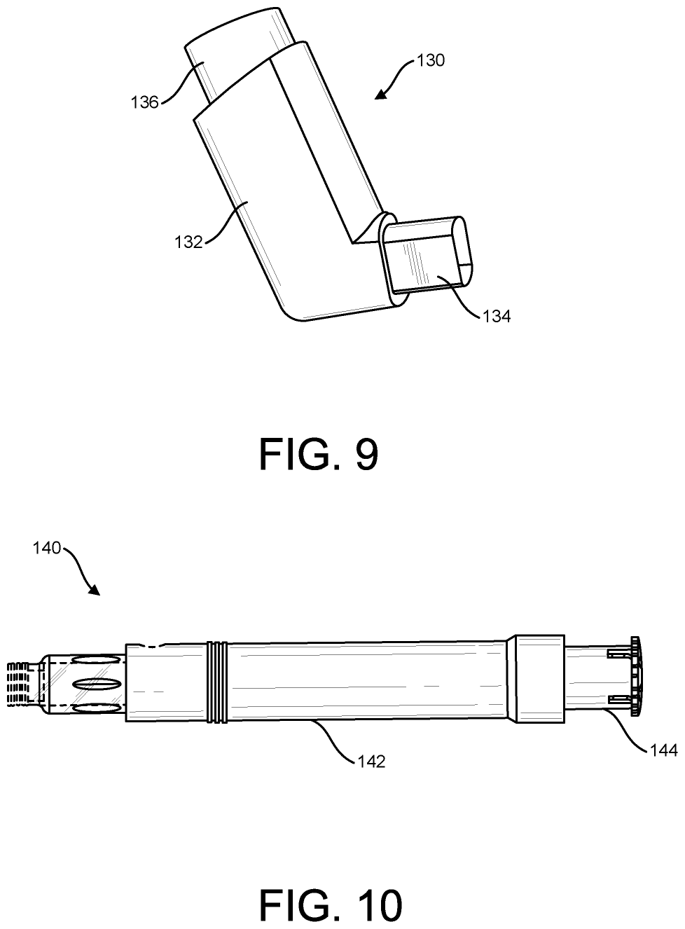

Referring to FIG. 9, for instance, an inhaler 130 is shown that may be made from the cellulose ester polymer composition. The inhaler 130 includes a housing 132 attached to a mouthpiece 134. In operative association with the housing 132 is a plunger 136 for receiving a canister containing a composition to be inhaled. The composition may comprise a spray or a powder.

During use, the inhaler 130 administers metered doses of a medication, such as an asthma medication to a patient. The asthma medication may be suspended or dissolved in a propellant or may be contained in a powder. When a patient actuates the inhaler to breathe in the medication, a valve opens allowing the medication to exit the mouthpiece. In accordance with the present disclosure, the housing 132, the mouthpiece 134 and the plunger 136 can all be made from a polymer composition as described above.

Referring to FIG. 10, another medical product that may be made in accordance with the present disclosure is shown. In FIG. 10, a medical injector 140 is illustrated. The medical injector 140 includes a housing 142 in operative association with a plunger 144. The housing 142 may slide relative to the plunger 144. The medical injector 140 may be spring loaded. The medical injector is for injecting a drug into a patient typically into the thigh or the buttocks. The medical injector can be needleless or may contain a needle. When containing a needle, the needle tip is typically shielded within the housing prior to injection. Needleless injectors, on the other hand, can contain a cylinder of pressurized gas that propels a medication through the skin without the use of a needle. In accordance with the present disclosure, the housing 142 and/or the plunger 144 can be made from a polymer composition as described above.

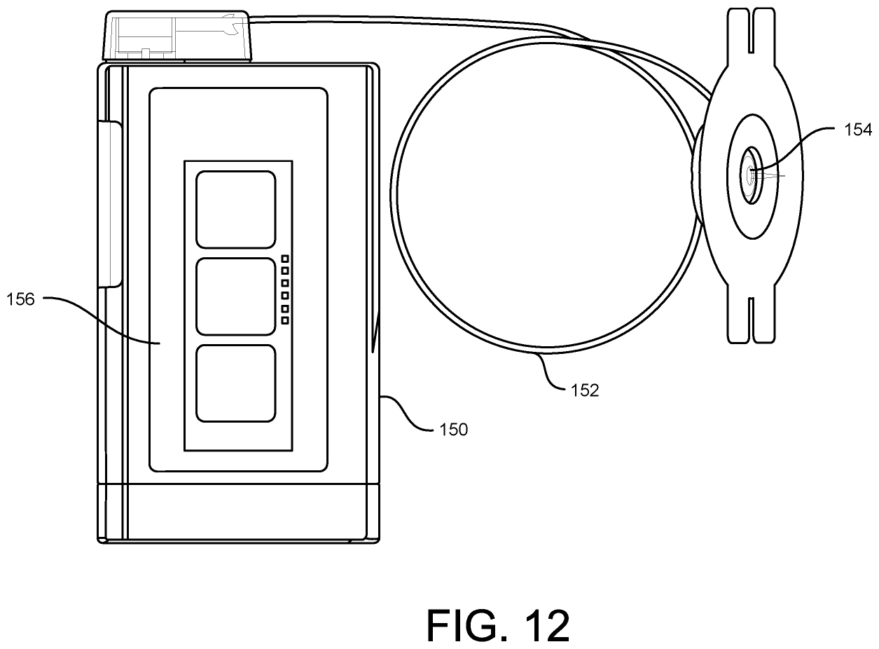

The medical injector 140 as shown in FIG. 10 can be used to inject insulin. Referring to FIG. 12, an insulin pump device 150 is illustrated that can include a housing 156 also made from the polymer composition of the present disclosure. The insulin pump device 150 can include a pump in fluid communication with tubing 152 and a needle 154 for subcutaneously injecting insulin into a patient.

The polymer composition of the present disclosure can also be used in all different types of laparoscopic devices. Laparoscopic surgery refers to surgical procedures that are performed through an existing opening in the body or through one or multiple small incisions. Laparoscopic devices include different types of laparoscopes, needle drivers, trocars, bowel graspers, rhinolaryngoscopes and the like.

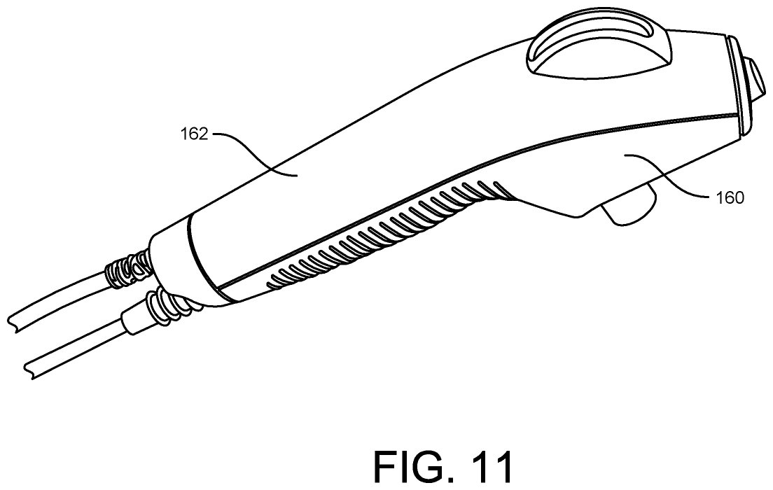

Referring to FIG. 11, for example, a rhinolaryngoscope 160 made in accordance with the present disclosure is shown. The rhinolaryngoscope 160 includes small, flexible plastic tubes with fiberoptics for viewing airways. The rhinolaryngoscope can be attached to a television camera to provide a permanent record of an examination. The rhinolaryngoscope 160 includes a housing 162 made from the polymer composition of the present disclosure. The rhinolaryngoscope 160 is for examining the nose and throat. With a rhinolaryngoscope, a doctor can examine most of the inside of the nose, the eustachian tube openings, the adenoids, the throat, and the vocal cords.

In order to produce the polymer composition of the present disclosure, the cellulose ester polymer, reactive flow aid, catalyst, and any other additives can be melt blended together. Melt blending the components together will cause the flow aid to form grafts on the polymer chains of the cellulose ester polymer or otherwise chemically associate with the cellulose ester polymer. In one embodiment, the different components can be fed to a heated mixing device. In one embodiment, the heated mixing device can be an extruder. The blended components can be heated to a temperature of generally greater than about 160° C., such as greater than about 180° C., such as greater than about 200° C., such as greater than about 220° C. The temperature is generally less than about 260° C., such as less than about 250° C., such as less than about 240° C., such as less than about 220° C., such as less than about 200° C. In one aspect, the reaction between the different components can occur very rapidly once the cellulose ester polymer has reached a molten state.

In one embodiment, the different components are melt processed together and formed into a compounded polymer resin. The polymer resin, for instance, can be in the form of pellets or granules. The pellets or granules can then be fed to a molding process for producing any of the molded articles described above.

### Example

Various cellulose ester polymer compositions were formulated and tested for flow properties. In this example, a caprolactone was used as a reactive flow aid. In particular, a caprolactone was added to the following compositions such that the resulting composition contained the caprolactone in an amount of 25% by weight. The caprolactone had a number average molecular weight of less than 8,000 g/mol.
Sample No. 1: Cellulose ester polymer 100 parts, citric acid 2.85 parts, diphosphite stabilizer 1.5 parts
Sample No. 2: Cellulose ester polymer 100 parts, phosphite antioxidant 0.15 parts
Sample No. 3: Cellulose ester polymer 100 parts

The above formulations were tested for melt flow rate at 190° C. and at a load of 2.16 kg. The following results were obtained:

| Sample No. | Melt Flow Rate g/10 min |
|---|---|
| 1 | 27.6 |
| 1 | 25.45 |
| 1 | 23.09 |
| 1 | 22.16 |
| 2 | 2.91 |
| 2 | 3.25 |
| 2 | 4.11 |
| 2 | 4.11 |
| 2 | 3.95 |
| 3 | 4.44 |
| 3 | 5.39 |
| 3 | 3.86 |

Sample Nos. 1 and 3 were also tested for intrinsic viscosity. Two measurements were taken, one at 300 rpm and one at 600 rpm. The following results were obtained:

| Sample No. 1 | Sample No. 1 | Sample No. 3 | Sample No. 3 |
|---|---|---|---|
| (300 rpm) | (600 rpm) | (300 rpm) | (600 rpm) |
| Intrinisic viscosity | | | |
| by Solomon-Ciuta | | | |
| (dL/g) | | | |
| 1.26 | 1.18 | 1.59 | 1.55 |

As shown above, the intrinsic viscosity of the cellulose acetate polymer was significantly reduced by addition of the citric acid in combination with the caprolactone.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a reaction product comprising:
(a) a cellulose ester polymer;
(b) a catalyst; and
(c) a reactive flow aid comprising a lactone or a polyester oligomer.

2. A polymer composition as defined in claim 1, wherein the lactone comprises caprolactone and the polyester oligomer comprises a polycaprolactone.

3. A polymer composition as defined in claim 1, wherein the reactive flow aid is the polyester oligomer and the polyester oligomer has a number average molecular weight of less than about 8,000 g/mol and greater than about 100 g/mol.

4. A polymer composition as defined in claim 1, wherein the catalyst comprises an acid species having a Pka value of from about 1 to about 8.

5. A polymer composition as defined in claim 4, wherein the catalyst has a Pka value of from about 2.5 to about 6.

6. A polymer composition as defined in claim 1, wherein the catalyst comprises an organic acid.

7. A polymer composition as defined in claim 1, wherein the catalyst comprises citric acid.

8. A polymer composition as defined in claim 1, wherein the catalyst comprises stearic acid, oxalic acid, palmitic acid, linoleic acid, lactic acid, acetic acid, formic acid, malic acid, peracetic acid, or mixtures thereof.

9. A polymer composition as defined in claim 1, wherein the cellulose ester polymer is present in the polymer composition in an amount from about 15% to about 95% by weight, and wherein the reactive flow aid is present in the composition in an amount greater than about 5% by weight and in an amount less than about 60% by weight, and wherein the catalyst is present in the composition in an amount from about 0.05% by weight to about 10% by weight.

10. A polymer composition as defined in claim 1, wherein the polymer composition further comprises a plasticizer.

11. A polymer composition as defined in claim 1, wherein the cellulose ester polymer comprises cellulose diacetate.

12. A polymer composition as defined in claim 1, wherein the reactive flow aid is present in the polymer composition sufficient to increase the melt flow rate by at least about 30% and less than about 2,000%.

13. A polymer composition as defined in claim 10, wherein the cellulose ester polymer is present in the polymer composition in an amount from about 55% by weight to about 95% by weight, and the plasticizer is present in an amount from about 5% by weight to about 40% by weight.

14. A polymer composition as defined in claim 1, wherein the plasticizer comprises triacetin, polyethylene glycol, or mixtures thereof.

15. A polymer composition as defined in claim 1, wherein the cellulose ester product further comprises an antioxidant, a stabilizer, an organic acid, an oil, filler particles, glass fibers, a pigment, a bio-based polymer other than the cellulose ester, a biodegradable enhancer, a foaming agent, or mixtures thereof.

16. A polymer composition as defined in claim 1, wherein the cellulose ester product further comprises a mineral filler, the mineral filler comprising talc, calcium carbonate, a metal oxide, mica, or mixtures thereof.

17. A polymer composition as defined in claim 1, wherein the cellulose ester product further comprises a coloring agent, the coloring agent comprising an organic dye, an inorganic dye, a pigment, or mixtures thereof.

18. A melt extruded article made from the polymer composition as defined in claim 1.

19. A melt extruded article as defined in claim 18, wherein the article is a beverage holder, a drinking straw, a hot beverage pod, or an interior automotive part.

20. A polymer composition as defined in claim 1, wherein the reactive flow aid is grafted to the cellulose ester polymer.

21. A polymer composition as defined in claim 1, wherein the polymer composition has a melt flow rate of greater than about 10 g/10 min and less than about 100 g/10 min.

22. A process for producing a polymer composition comprising:
heating and blending together a cellulose ester polymer and a reactive flow aid in the presence of a catalyst, the blended components being heated to a temperature sufficient for the reactive flow aid to graft to the cellulose ester polymer.
